(19) United States
(12) Patent Application Publication
(10) Pub. No.: US 2005/0040364 A1
(43) Pub. Date: Feb. 24, 2005

(54) Liquid crystalline laterally polymerizable compounds

(76) Inventors: Zoubair Mohammed Cherkaoui, Allschwil (DE); Thomas Peglow, Lorrach (DE); Carsten Benecke, Weil am Rhein (DE)

Correspondence Address: SUGHRUE MION, PLLC, 2100 PENNSYLVANIA AVENUE, N.W., SUITE 800, WASHINGTON, DC, 20037, US

(21) Appl. No.: 10/490,423

(22) PCT Filed: Sep. 23, 2002
(86) PCT No.: PCT/CH02/00525

(30) Foreign Application Priority Data
Sep. 24, 2001 (EP) 01810929.8

(51) Int. Cl. C09K 19/38; C09K 19/52; C09K 19/34; C09K 19/32; C09K 19/30; C09K 19/20

(52) U.S. Cl. 252/299.01; 252/299.61; 252/299.62; 252/299.63; 428/1.1; 252/299.67

(57) ABSTRACT

Chiral or achiral compounds of formula (I) wherein —(C¹—X¹)ₙ₁—C²—(X²—C³)ₙ₂— is a rod-like core formed by a substantially linear arrangement of the residues represented by the symbols and A includes a polymerizable group, as well as LCP networks thereof.

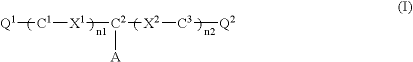

The invention relates to new liquid crystalline compounds, mixtures of those compounds and their application in optical devices. More particularly, it relates to the use of a component of a polymerizable liquid crystalline mixture in the production of orientated liquid crystalline polymers; compounds used as components in polymerizable liquid crystalline mixtures; liquid crystalline mixtures comprising these components; liquid crystalline polymers and networks prepared from such components; and liquid crystalline devices comprising those compounds.

Liquid crystal polymers (LCPs) and/or liquid crystal networks are used in the manufacture of optical components such as waveguides, optical gratings, filters, retarders, rotators, piezoelectric cells and non-linear optical cells and films. The choice of LCP for use in any one of the aforementioned optical components depends upon its associated optical properties such as the optical anisotropy, refractive index, transparency and dispersion. Optical filters, for example, contain LCPs having a large anisotropy (Δn) and a low dispersion (n=f(λ)).

LCPs are manufactured by orientating a layer of a polymerizable liquid crystal single compound or mixture and cross-linking the mesogenic layer to form a liquid crystal polymer (LCP) network. Polymerizable LC compounds used in the manufacture of the LCPs need to be chemically and thermally stable, stable to electromagnetic radiation, soluble in standard solvents and miscible with other LC components, and to exhibit liquid crystalline properties over the range 25 to 80° C., more advantageously 25 to 150° C. The configuration imposed by an orientation layer on the polymerizable LC single compound or mixture becomes fixed or frozen into the LCP network formed upon cross-linking. The resulting LCP films have a high viscosity and are stable to mechanical stresses, temperature and light exposure.

There is therefore a need for a liquid crystalline single compound or mixture which exhibits a broad liquid-crystalline thermal range and which can be orientated on a substrate prior to cross-linking in such a way that the orientation of the LC single compound or mixture on the substrate remains stable over the period required for manufacturing the LCP network. Components which may be used in photocrosslinkable liquid crystalline layers are particularly desirable.

In previous mesogenic polymerizable compounds the polymerizable residues are attached to the mesogenic core mainly at positions ahead its long molecular axis. However, this impedes the adjustment of the desired aforementioned properties of a LCP material by suitable substituents along the long molecular axis, as for example the induction of an anisotropic permanent dipole moment by a polar substituent Therefore, a new architecture for obtaining LCP materials was investigated, which relies on attaching of at least one polymerizable group laterally to the mesogenic core to free a peripheral position for an optional substituent ahead the long molecular axis. In addition, and as it will be demonstrated in the following examples, it was surprisingly found that a network manufactured by cross-linking an orientated layer of a liquid crystalline laterally polymerizable single compound or a mixture still exhibits anisotropic properties after curing, at least similar to those obtained with standard LCPs. Moreover, the compounds of the present invention enable the manufacture of LCP networks which are homogeneous and conserve the long molecular axis orientation induced at the monomeric scale.

Thus, the invention provides chiral or achiral compounds of formula (I): 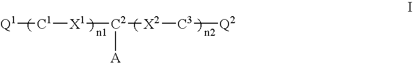
wherein:
—(C¹—X¹)ₙ₁—C²—(X²—C³)ₙ₂— is a rod-like core formed by a substantially linear arrangement of the residues represented by the symbols;
A includes a polymerizable group and represents an optionally-substituted methyl group; or an optionally-substituted hydrocarbon group of 2 to 20 C-atoms, in which one or more C-atoms may be replaced by a heteroatom, in such a way that oxygen atoms are not linked to one another,
C¹ to C³ are in each case independently optionally-substituted nonaromatic, aromatic, carbocyclic or heterocyclic groups; preferably connected to each other at the opposite positions via the bridging groups X¹ and X², such as in standard mesogenic molecular architecture;
Q¹ represents an optionally-substituted methyl group; or an optionally-substituted hydrocarbon group of 2 to 20 C-atoms, in which one or more C-atoms may be replaced by a heteroatom, in such a way that oxygen atoms are not linked to one another; and which may comprise a polymerizable group;
Q² represents hydrogen; halogen; a polar group such as —CN and —NO₂; an optionally-substituted methyl group; an optionally-substituted hydrocarbon group of 2 to 20 C-atoms, in which one or more C-atoms may be replaced by a heteroatom, in such a way that oxygen atoms are not linked to one another; and may comprise a polymerizable group when Q¹ does not comprise a polymerizable group
X¹and X² each independently represent —O—, —S—, —NH—, —N(CH₃)—, —N═N—, —CO—C═C—, —CH(OH)—, —CO—, —CH₂(CO)—, —SO—, —CH₂(SO)—, —SO₂—, —CH₂(SO₂)—, —COO—, —OCO—, —OCO—O—, —S—CO—, —CO—S—, —SOO—, —OSO—, —SOS—, —CH₂—CH₂—, —OCH₂—, —CH₂O—, —CH═CH—, —C≡C— or a single bond; and
n1 and n2 are integers, each independently having a value from 1 to 4;
   with the proviso that at least one of Q1 and Q2 comprises a polymerizable group.

The term “hydrocarbon” includes straight-chain and branched alkylene, as well as saturated and unsaturated groups. Possible substituents include alkyl, aryl (thus giving an araliphatic group) and cycloalkyl, as well as amino, cyano, epoxy, halogen, hydroxy, nitro, oxo etc. Possible heteroatoms which may replace carbon atoms include nitrogen, oxygen and sulphur. In the case of nitrogen further substitution is possible with groups such as alkyl, aryl and cycloalkyl. Likewise, the terms “alkyl” and “alkylene”, as used herein, includes straight-chain and branched groups, as well as saturated and unsaturated groups

To an expert in liquid crystals, the molecular architecture of compounds of formula (I) would not have been thought to be favorable for obtaining anisotropic properties after cross-linking, because it is well known that the liquid crystalline thermal range decreases as the volume of the lateral substituent increases. Thus, the dramatic increase of the lateral substituent upon curing would have been thought to cause a considerable loss of the molecular lateral registry within the orientated mesogenic bulk of the monomers. However, we have now surprisingly found that compounds of formula (I) are suitable for the formation of networks that exhibit anisotropic properties comparable to those measured at the monomeric scale.

In a first preferred embodiment of the present invention, the group A may be selected from a residue of formula (II):
P¹-(Sp¹)ₘ₁-(Y¹)ₖ₁- II
wherein:
P¹ is a polymerizable group selected from groups comprising CH₂═CW—, CH₂═CW—COO—, CH₂═C(Ph)-COO—, CH₂═CH—COO-Ph-, CH₂═CW—CO—NH—, CH₂═C(Ph)-CONH—, CH₂═C(COOR′)—CH₂—COO—, CH₂═CH—O—, CH₂═CH—OOC—, (Ph)-CH═CH—, CH₃—CH═N—(CH₂)ₚ₁—, HO—, HS—, HO(CH₂)ₚ₁COO—, HS(CH₂)ₚ₁COO—, HWN—, HOC(O)—, CH₂═CH-Ph-(O)ₚ₂, 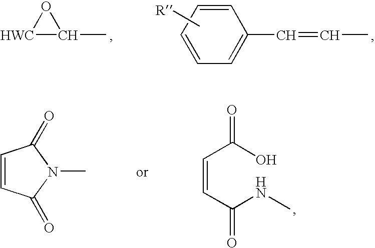
   wherein:
   w represents H, F, Cl, Br or I or a C₁₋₅ alkyl group;
   p1 is an integer having a value of from 1 to 9;
   p2 is an integer having a value of 0 or 1,
   R′ represents a C₁₋₅ alkyl group; and
   R″ represents a C₁₋₅ alkyl group, methoxy, cyano, F, Cl, Br or I;
Sp¹ represents an optionally-substituted C₁₋₂₀ alkylene group, in which one or more C-atoms may be replaced by a heteroatom or/and by an optionally substituted aromatic or non-aromatic carbocyclic or heterocyclic 3- to 10-membered ring system, preferably an optionally substituted carbocyclic or heterocyclic 3-membered ring system, or/and it is optionally possible that one or more carbon-carbon single bonds are replaced by carbon-carbon double or triple bond;
m1 is an integer having a value of 0 or 1;
Y¹ represents —O—, —S—, —NH—, N(CH₃)—, —CH(OH)—, —CO—, —CH₂(CO)—, —SO—, —CH₂(SO)—, —SO₂—, —CH₂(SO₂)—, —COO—, —OCO—, —OCO—O—, —S—CO—, —CO—S—, —SOO—, —OSO—, —SOS—, —CH₂—CH₂—, —OCH₂—, —CH₂O—, —CH═CH—, or —C≡C—; and
k1 is an integer having a value of 0 or 1.

In relation to the residue of formula (II), the term Ph is to be understood as denoting phenylene and (Ph) as denoting phenyl.

The C₁₋₂₀ alkylene group Sp¹ may comprise branched or straight chain alkylene groups and may be unsubstituted, mono- or polysubstituted by F, Cl, Br, I or CN. Alternatively or in addition one or more of CH₂ groups present in the hydrocarbon chain may be replaced, independently, by one or more groups selected from —O—, —S—, —NH—, —N(CH₃)—, —CH(OH)—, —CO—, —CH₂(CO)—, —SO—, —CH₂(SO)—, —SO₂—, —CH₂(SO₂)—, —COO—, —OCO—, —OCO—O—, —S—CO—, —CO—S—, —SOO—, —OSO—, —SOS—, —C≡C—, —(CF₂)_{q1}-, or —C(W¹)═C(W²)—, with the proviso that two oxygen atoms are not directly linked to each other. W¹ and W² each represent, independently, H, H—(CH₂)_{q3} or Cl. The integers q1 to q3 each independently represent a number of between 1 and 15.

More preferably, the group A represents a group of formula (III):
P²-(Sp²)ₘ₁-Y²- III
wherein:
Y² represents —O—, —CO—, —COO—, —OCO—, —C≡C—, or a single bond, especially —O—, —COO—, —OCO— or a single bond;
Sp² represents a C₁₋₂₀ straight-chain alkylene group, especially ethylene, propylene, butylene, pentylene, hexylene, heptylene, octylene, nonylene, decylene, undecylene, or dodecylene; and
P² represents a polymerizable group such as: CH₂═CW³— or CH₂═CW³—(CO)ₚ₃O—
   wherein:
   W³ represents H, CH₃, F, Cl, Br or I; and
   p³ is 0 or 1.

The group Q¹ is preferably selected from a residue of formula (IV):
P³-Sp¹-(Y¹)ₖ₁- IV
wherein:
P³ is hydrogen or a polymerizable group P¹ with the meaning given above; and
Sp¹, Y¹ and k1 have the meaning given above.

More preferably, Q¹ is selected from a residue of formula (V):
P⁴-Sp²-Y²- V
wherein:
P⁴ is hydrogen or a polymerizable group P² with the meaning given above; and
Sp² and Y² have the meaning given above.

The group Q² is preferably selected from a residue of formula (VI):
P⁵-(Sp¹)ₘ₁-(Y¹)ₖ₁- VI
wherein:
P⁵ is hydrogen; halogen; a polar group such as —CN, and —NO₂; or a polymerizable group P¹ with the meaning given above and with the proviso that Q¹ does not comprise a polymerizable group; and
Sp¹, m1, Y¹ and k¹ have the meaning given above.

More preferably, Q² is selected from a residue of formula (VII):
P⁵-(Sp²-Y²)ₘ₃- VII
P⁵ is hydrogen; halogen; a polar group such as —CN, and —NO₂; or a polymerizable group P² with the meaning given above and with the proviso that Q¹ does not comprise a polymerizable group;
m3 is an integer having a value of 0 or 1; and
Sp² and Y² have the meaning given above.

In a second preferred embodiment of the present invention, the groups C¹ and C³ are selected from: 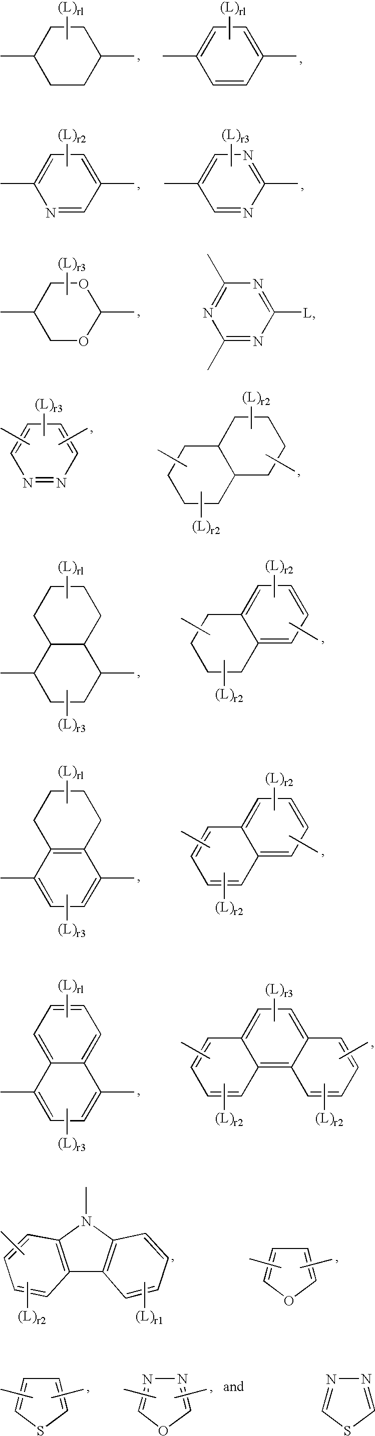
with:
L being —CH₃, —COCH₃, —NO₂, —CN, or halogen
r1 being 0, 1, 2, 3, or 4,
r2 being 0, 1, 2, or 3, and
r3 being 0, 1, or 2.

It is especially preferred that C¹ and C³ are selected from the group consisting of optionally-substituted trans-1,4-cyclohexylene, 1,4-phenylene and 2,6-naphthylenediyl.

The group C² is preferably selected from: 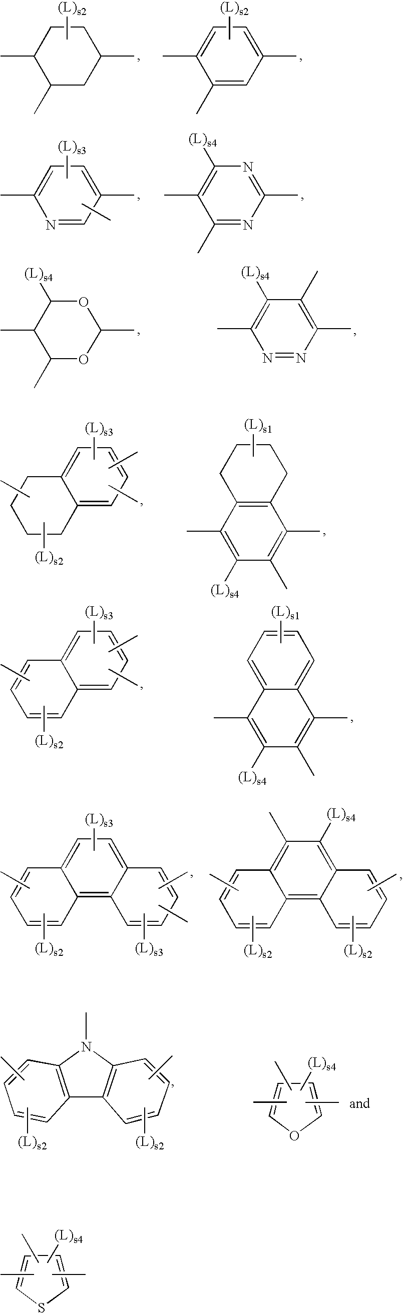
with:
L being —CH₃, —COCH₃, —NO₂, —CN, or halogen,
s1 being 0, 1, 2, 3, or 4,
s2 being 0, 1, 2, or 3,
s3 being 0, 1, or 2 and
s4 being 0 or 1.

It is especially preferred that C² is selected from the group consisting of optionally-substituted 1,2,4-cyclohexatriyl, 1,2,4-benzenetriyl, 1,2,4-naphthenetriyl, 1,2,6-naphthenetriyl and 2,3,6-naphthenetriyl.

The groups X¹ and X² are preferably independently selected from the group consisting of —COO—, —OCO—, —CH₂—CH₂—, —CH₂O—, —OCH₂—, —CH═CH—, —C≡C— and a single bond.

It is especially prefered that X¹ and X² are independently selected from the group consisting of of —COO—, —OCO— and a single bond.

The integers n1 and n2 have preferably independently a value from 1 to 3. It is especially preferred that the sum of n1+n2 is 2, 3 or 4.

A further preferred embodiment of the present invention are compounds according to formula (I), in which:
A is a residue selected from the formula (VIII)
   Y³-(Sp²)ₙ₃-P² VIII
   wherein:
   Y³ represents —O—, —COO—, —OCO— or a single bond;
   n3 is an integer having a value of 0 or 1; and
   Sp² and P² have the meaning given above;
Q¹ is a residue selected from the formula (IX)
   P⁴-Sp²-Y³ IX
   wherein:
   P⁴, Sp² and Y³ have the meaning given above;
Q² is hydrogen; halogen; CN; a polymerizable group P² with the meaning given above and with the proviso that Q¹ does not comprise a polymerizable group; or a residue selected from the formula (X)
   CH₃-(Sp²)ₙ₃-Y³ IX
   wherein:
   Sp², n3 and Y³ have the meaning given above;
C¹ to C³, X¹ and X² have the meaning given above; and
n1 and n2 are integers, wherein the sum of n1+n2 is 2, 3 or 4.

Furthermore, it should be understood that generally one or more hydrogen atoms in the compounds of the present invention may be replaced by deuterium, in particular at saturated carbon atoms and especially in saturated cyclic moieties such as cyclohexane radicals.

The compounds of the invention may be readily prepared using methods that are well known to the person skilled in the art, such as those documented in Houben-Weyl, Methoden der Organischen Chemie, Thieme-Verlag, Stuttgart. The compounds may for example be made according to the reaction schemes 1 and 2 in which the following abbreviation are used:
DEAD is Diethyl azodicarboxylate
TPP is Triphenylphosphine
THF is Tetrahydrofurane
DMF is N,N-Dimethylformamide
Et₃N is Triethylamine
DCM is Dichloromethane
DCC is N,N′-dicyclohexylcarbodiimide
DMAP is 4-Dimethylaminopyridine
n-BuLi is n-Butyllithium
TMEDA is N,N,N′,N′-Tetramethylethylenediamine
DBU is 1,8-Diazabicyclo[5.4.0]undec-7-en
EE is Ethylacetate
p-TsOH is p-Toluenesulfonic acid

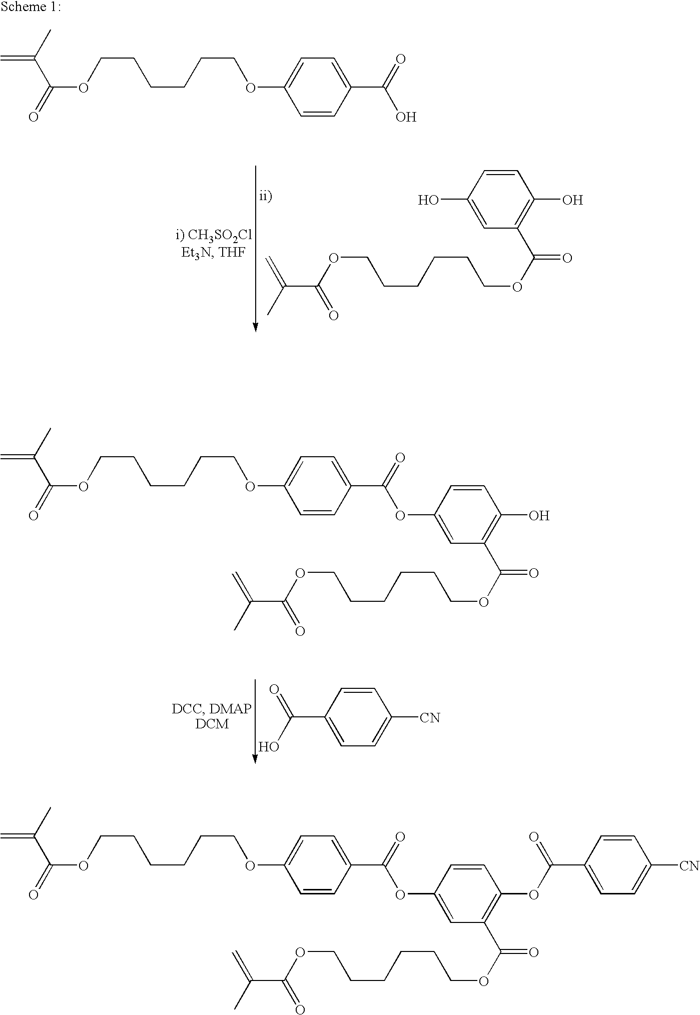

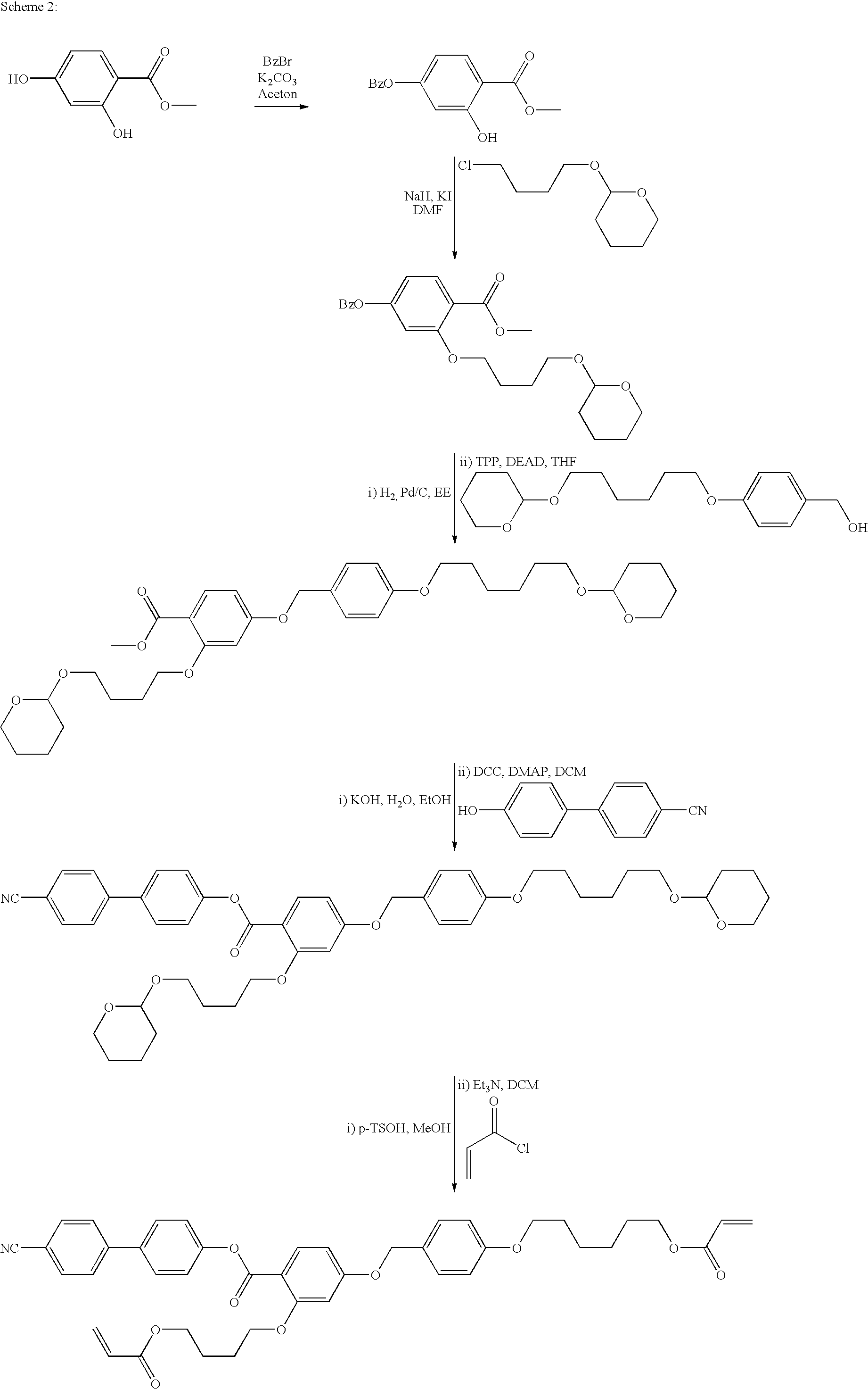

Based on the synthetic ways drawn in Schemes 1 and 2, typical examples representing “laterally polymerizable” derivatives of formula (I) and shown in the following list of compounds may be prepared. This list is, however, to be understood only as illustrative without limiting the scope of the present invention:

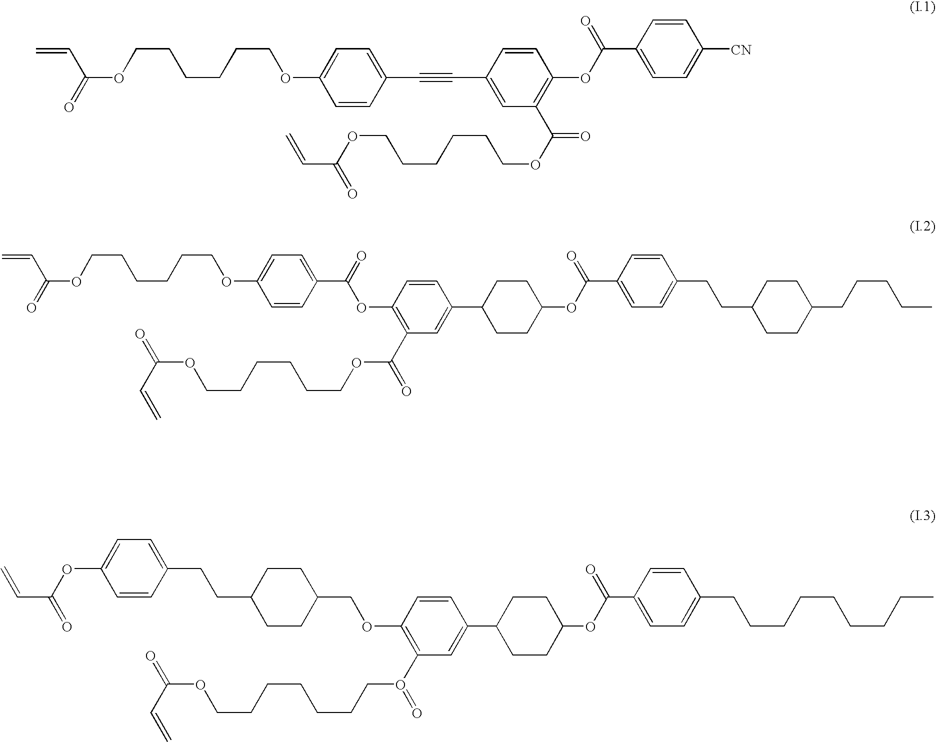

The liquid crystalline “laterally polymerizable” compounds of formula (I) may be used alone or as a component of a liquid crystal mixture. Liquid crystalline materials comprising a compound of formula (I) may be used in the manufacture of LCPs. A second aspect of the invention therefore comprises a liquid crystalline material comprising a compound of formula (I). Preferably, the liquid crystalline materials comprise at least two components. The additional components must be miscible with the compound of formula (I) and may be selected from known mesogenic materials such as those reported in Adv. Mater. 5, 107 (1993), Mol. Cryst. Liq. Cryst. 307, 111 (1997), J. Mat. Chem. 5, 2047 (1995) or in patents and patent applications U.S. Pat. No. 5,593,617; U.S. Pat. No. 5,567,349; GB-A-2 297 556; GB-A-2 299 333; U.S. Pat. No. 5,560,864; EP-A-0 606 940; EP-A-0 643 121 and EP-A-0 606 939.

The form of the liquid crystal material will depend upon the application in which it is to be used and may be present as a liquid crystalline mixture, (co)polymer, elastomer, polymer gel or polymer network Polymer networks have been found to be of particular use and in a further preferred embodiment of the invention there is provided a polymer network comprising a compound of formula (I). Preferably the polymer network comprises at least two components, at least one of which is a liquid crystalline “laterally polymerizable” compound of formula (I).

The polymer network may be prepared by copolymerization of a mesogenic mixture comprising:
i) at least one chiral or/and achiral mesogenic polymerizable compound;
ii) at least one “laterally polymerizable ” compound of formula I; and
iii) an initiator.

The chiral or achiral mesogenic polymerizable compound may be a liquid crystalline “laterally polymerizable” compound of formula (I). Alternatively or in addition, the polymerizable compound may be selected from the known mesogenic materials referred to above. Preferably, the chiral or achiral polymerizable compound has a thermotropic sequence which includes a nematic phase.

The polymer network may optionally comprise further components. These include further polymerizable compounds, stabilizers and dyes. The additional polymerizable compounds preferably comprise a non-mesogenic compound having at least one polymerizable functional group, especially diacrylate compounds.

Any suitable stabilizer that prevents undesired spontaneous polymerization, for example during storage of the mixture, may be used in liquid crystalline mixtures of the present invention. A broad range of these compounds is commercially available. Typical examples include 4-ethoxyphenol or 2,6-di-tert-butyl-4-methylphenol (BHT).

For color filters, dyes may be added to the mixture. It is, however, preferred to prepare liquid crystalline mixtures containing no dye.

The chiral or achiral polymerizable mesogenic compound may be present in an amount comprising 0.01 to 99% by weight of the polymer network, preferably 50 to 95% by weight.

The liquid crystalline “laterally polymerizable” compound of formula (I) may be present in an amount from 0.1 to 100% by weight of the polymer network, preferably from 1 to 50% by weight.

The initiator is preferably a photoinitiator and may be a radical or cationic initiator that is present in an amount comprising 0.1 to 5% by weight of the polymer network, preferably from 0.2 to 2% by weight.

When the mixture further comprises stabilizers, these are generally present in an amount comprising 0.01 to 5% by weight of the liquid crystalline mixture, preferably from 0.1 to 1% by weight.

These polymerizable liquid crystalline mixtures may be formed into liquid crystalline polymer (LCP) networks in form of films and a third aspect of the invention provides a LCP film comprising a compound of formula (I). Such LCP networks in form of a film may be readily prepared by polymerization, e.g. UV polymerization, of a LC mixture according to the invention; a film comprising the LC mixture is formed on a substrate and polymerized using UV light to give a cross-linked liquid crystal polymer (LCP) film. The film is both light and temperature stable and can be used in the manufacture of devices such as waveguides, optical gratings, filters, retarders, rotators, piezoelectric cells or thin films exhibiting non-linear optical properties.

Different methods can be used for the formation of the LCP network. Transparent substrates such as coated ITO (indium tin oxide), glass, plastic or silicone substrates, may be used. Preferred substrates include glass or plastic, especially those including a layer of rubbed polyimide or polyamide or a layer of photo-oriented photopolymer such as a linearly photopolymerized polymer (LPP). The preferred substrates greatly facilitate uniform orientation of the liquid crystalline mixture.

In the preparation of LCP films, it is particularly important to prevent the formation of defects or inhomogenities. This can be achieved by forming the polymerizable liquid crystalline mixture into a thin film; and placing the mixture between two of the aforementioned substrates which are then sheared over a small distance until a planar order was obtained; or capillary filling the polymerizable liquid crystalline mixture between two of the said substrates; prior to curing, for example by UV light, preferably in the presence of a photoinitiator, such as IRGACURE™.

A fourth aspect of the invention provides an optical or electro-optical component containing a liquid crystalline polymer film comprising a compound of formula (I). The optical or electro-optical component may be a waveguide, an optical grating, a filter, a retarder, a rotator, a piezoelectric cell or a non-linear optical cell or film.

The invention will now be described with reference to the following examples. Variations on these falling within the scope of the invention will be apparent to a person skilled in the art.

In the following examples the thermotropic phases are abbreviated as follows: K for crystalline, S for smectic, N for nematic, and I for isotropic.

### EXAMPLE 1

### 6-(Methacryloyloxy)hexyl 2-[(4-cyanobenzoyl)oxy]-5-[(4-{[6-(methacryloyloxy)hexyl]oxy}benzoyl)oxy]benzoate

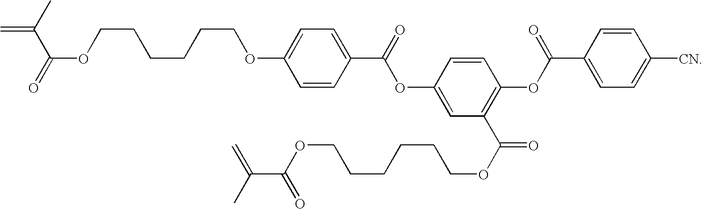 1) 6-(Methacryloyloxy)hexyl 2-hydroxy-5-[(4-{[6-(methacryloyloxy)hexyl]oxy}benzoyl)oxy]benzoate

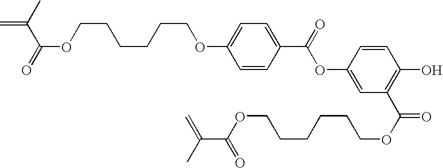

To a stirred solution of 4-{[6-(methacryloyloxy)hexyl]oxy}benzoic acid (7.82 g) in 60 ml of dry THF was added dropwise triethylamine (8.90 g) at +30° C., followed by mesyl chlorid (2.92 g). After complete addition, the reaction mixture was further stirred for 1 h at −30° C., then a solution of 6-(methacryloyloxy)hexyl 2,5-dihydroxybenzoate (7.09 g) in 30 ml of dry THF was added dropwise. The reaction mixture was further stirred at −30° C. for 30 min, then at room temperature overnight. The reaction mixture was filtered over celite and the filter cake was washed with ethyl acetate. The filtrate was poured on 150 ml of water, the organic phase separated and washed with 100 ml of water, dried over magnesium sulfate and evaporated to dryness. The residue was flash chromatographed on silica gel using cyclohexane/ethyl acetate: 3/1 as eluent to afford pure 6-(methacryloyloxy)hexyl 2-hydroxy-5-[(4-{[6-(methacryloyloxy)-hexyl]oxy}benzoyl)oxy]benzoate as colorless oil.

Yield: 9.81 g.
2) 6-(Methacryloyloxy)hexyl 2-[(4-cyanobenzoyl)oxy]-5-[(4-{[6-(methacryloyloxy)hexyl]oxy}benzoyl)oxy]benzoate

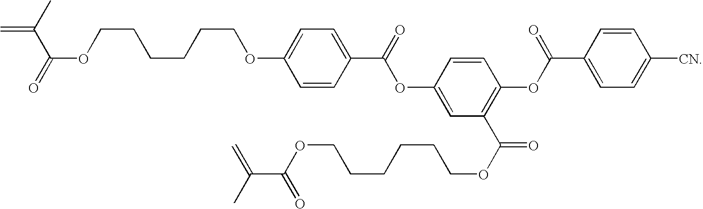

A solution of 6-(methacryloyloxy)hexyl 2-hydroxy-5-[(4-{[6-(methacryloyloxy)-hexyl]oxy}benzoyl)oxy]benzoate (1.83 g), 4-cyanobenzoic acid (0.48 g), DCC (0.68 g) and DMAP (0.41 g) in 20 ml of DCM was stirred overnight, filtered and the filtrate was evaporated to dryness. The residue was flash chromatographed on silica gel using cyclohexane/ethyl acetate: 11/4 as eluent to afford the desired product. Further purification by recrystallization from aceton/ethanol gave pure 6-(methacryloyloxy)-hexyl 2-[(4-cyanobenzoyl)oxy]-5-[(4-{[6-(methacryloyloxy)hexyl]oxy}benzoyl)oxy]-benzoate as white powder.

Yield 1.40 g.

This compound has the following thermotropic sequence:
Cr 54° C. (N 44° C.) I.

### EXAMPLE 2

### 6-(Methacryloyloxy)hexyl 2-({4-[(4-cyanobenzoyl)oxy]benzoyl}oxy)-5-[(4-{[6-(methacryloyloxy)hexyl]oxy}benzoyl)oxy]benzoate

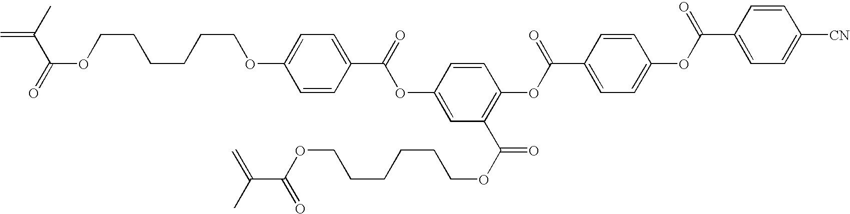 1) 6-(Methacryloyloxy)hexyl 5-[(4-{[6-(methacryloyloxy)hexyl]oxy}benzoyl)-oxy]-2-{[4-(tetrahydro-2H-pyran-2-yloxy)benzoyl]oxy}benzoate

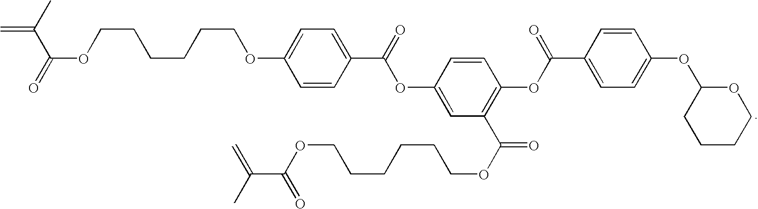

A solution of 6-(methacryloyloxy)hexyl 2-hydroxy-5-[(4-{[6-(methacryloyloxy)-hexyl]oxy}benzoyl)oxy]benzoate (2.44 g), 4-(tetrahydro-2H-pyran-2-yloxy)benzoic acid (0.98 g), DCC (0.90 g) and DMAP (0.54 g) in 20 ml of DCM was stirred overnight, filtered and the filtrate was evaporated to dryness. The residue was flash chromatographed on silica gel using cyclohexane/ethyl acetate: 11/4 as eluent to afford pure 6-(methacryloyloxy)hexyl 5-[(4-{[6-(methacryloyloxy)hexyl]-oxy}benzoyl)oxy]-2-{[4-(tetrahydro-2H-pyran-2-yloxy)benzoyl]oxy}benzoate as colorless oil.

Yield 3.25 g.
2) 6-(Methacryloyloxy)hexyl 2-[(4-hydroxybenzoyl)oxy]-5-[(4-{[6-(methacryloyloxy)hexyl]oxy}benzoyl)oxy]benzoate

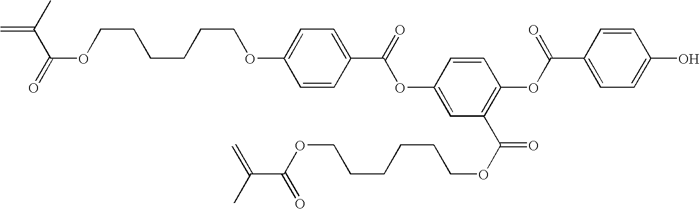

A stirred solution of 6-(methacryloyloxy)hexyl 5-[(4-{[6-(methacryloyloxy)hexyl]-oxy}benzoyl)oxy]-2-{[4-(tetrahydro-2H-pyran-2-yloxy)benzoyl]oxy}benzoate (3.10 g) and BTSS (0.05 g) in 30 ml of methanol was refluxed for 3 h The reaction mixture was then evaporated, poured on 50 ml of ethyl acetate; washed with 50 ml of water, dried over sodium sulfate and evaporated to dryness. The residue was flash chromatographed on silica gel using cyclohexane/ethyl acetate: 3/1 as eluent to afford pure 6-(methacryloyloxy)hexyl 2-[(4-hydroxybenzoyl)oxy]-5-[(4-{[6-(methacryloyloxy)-hexyl]oxy}benzoyl)oxy]benzoate as colourless oil.

Yield 1.22 g.
3) 6-(Methacryloyloxy)hexyl 2-({4-[(4-cyanobenzoyl)oxy]benzoyl}oxy)-5-[(4-{[6-(methacryloyloxy)hexyl]oxy}benzoyl)oxy]benzoate

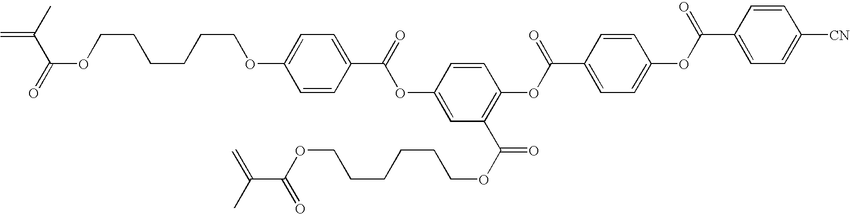

A solution of 6-(methacryloyloxy)hexyl 2-[(4-hydroxybenzoyl)oxy]-5-[(4-{[6-(methacryloyloxy)-hexyl]oxy}benzoyl)oxy]benzoate (1.10 g), 4-cyanobenzoic acid (0.23 g), DCC (0.37 g) and DMAP (0.22 g) in 30 ml of DCM was stirred overnight, filtered and the filtrate was evaporated to dryness. The residue was flash chromatographed on silica gel using cyclohexane/ethyl acetate: 3/1 as eluent to afford the desired product. Further purification by recrystallization from aceton/ethanol gave pure 6-(methacryloyloxy)hexyl 2-({4-[(4-cyanobenzoyl)oxy]benzoyl}oxy)-5-[(4-{[6-(methacryloyloxy)hexyl]oxy}benzoyl)oxy]benzoate as white powder.

Yield 0.83 g

This compound has the following thermotropic sequence:

Cr 89° C. N 160° C. I.

### EXAMPLE 3

### Preparation of Nematic LCP Films

A solution of the following component in Anisole was prepared:
97 wt % of

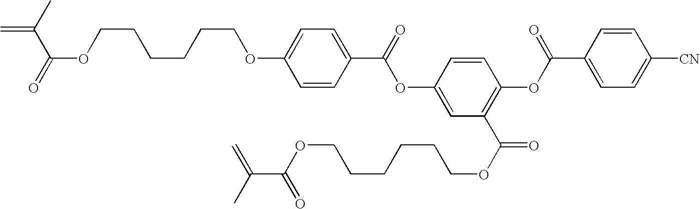

Further 1000 ppm Tinuvin 123 were added as a stabilizer, 1000 ppm of 2,6-di-(t-butyl)-4-hydroxytoluene (BHT) inhibitor were added to this mixture in order to prevent polymerization. Polymerization was started using 1000 ppm initiator such as Irgacure 369 (commercially available from Ciba Geigy, Basel, Switzerland). The mixture was stirred at room temperature and than spincoated on a glass plate having an orientation layer to form an LCP film of ca. 800 nm in thickness. This film was dried at 50° C. for 1 or 2 minutes and photopolymerized by irradiation with UV light for approximately 5 minutes at room temperature in a N₂ atmosphere using a mercury lamp.

The well oriented film shows the nematic mesophase at room temperature. In addition, this film exhibits a mean tilt angle of about 50° relative to the plane of the substrate, as shown by ellipsometric measurements.

1. Compounds of formula (I): 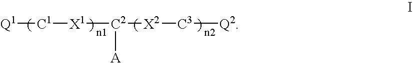
wherein:
—C¹—X¹)ₙ₁—C²—(X²—C³)ₙ₂— is a rod-like core formed by a substantially linear arrangement of the residues represented by the symbols;
A includes a polymerizable group and represents an optionally-substituted methyl group; or an optionally-substituted hydrocarbon group of 2 to 20 C-atoms, in which one or more C-atoms may be replaced by a heteroatom, in such a way that oxygen atoms are not linked to one another,
C¹ to C³ are in each case independently optionally-substituted non-aromatic, aromatic, carbocyclic or heterocyclic groups; preferably connected to each other at the opposite positions via the bridging groups X¹ and X²;
Q¹ represents an optionally-substituted methyl group; or an optionally-substituted hydrocarbon group of 2 to 20 C-atoms, in which one or more C-atoms may be replaced by a heteroatom, in such a way that oxygen atoms are not linked to one another, and which may comprise a polymerizable group;
Q² represents hydrogen; halogen; a polar group such as —CN and —NO₂; an optionally-substituted methyl group; an optionally-substituted hydrocarbon group of 2 to 20 C-atoms, in which one or more C-atoms may be replaced by a heteroatom, in such a way that oxygen atoms are not linked to one another, and may comprise a polymerizable group when Q¹ does not comprise a polymerizable group;
X¹ and X² each independently represent —O—, —S—, —NH—, —N(CH₃)—, —N═N—, —CO—C═C—, —CH(OH)—, —CO—, —CH₂(CO)—, —SO—, —CH₂(SO)—, —SO₂—, —CH₂(SO₂)—, —COO—, —OCO—, —OCO—O—, —S—CO—, —CO—S—, —SOO—, —OSO—, —SOS—, —CH₂—CH₂—, —OCH₂—, —CH₂O—, —CH═CH—, —C≡C— or a single bond; and
n1 and n2 are integers, each independently having a value from 1 to 4;
with the proviso that at least one of Q1 and Q2 comprises a polymerizable group.

2. Compound according to claim 1, wherein hydrocarbon includes straight-chain and branched alkylene, as well as saturated and unsaturated groups.

3. Compound according to claims 1 or 2, wherein the substituents include alkyl, aryl, cycloalkyl, amino, cyano, epoxy, halogen, hydroxy, nitro, and oxo groups.

4. Compound according to anyone of claims 1 to 3, wherein the heteroatoms which may replace carbon atoms include nitrogen, oxygen and sulphur.

5. Compound according to claim 4, wherein the nitrogen atom is substituted with groups such as alkyl, aryl and cycloalkyl.

6. Compound according to anyone of claims 1 to 5, wherein the group A may be selected from a residue of formula (II):
P¹-(Sp¹)ₘ₁-(Y¹)ₖ₁- II
wherein:
P¹ is a polymerizable group selected from groups comprising CH₂═CW—, CH₂═CW—COO—, CH₂═C(Ph)-COO—, CH₂═CH—COO-Ph-, CH₂═CW—CO—NH—, CH₂═C(Ph)-CONH—, CH₂═C(COOR′)—CH₂—COO—, CH₂═CH—O—, CH₂═CH—OOC—, (Ph)-CH═CH—, CH₃—CH═N—(CH₂)ₚ₁—, HO—, HS—, HO(CH₂)ₚ₁COO—, HS(CH₂)ₚ₁COO—, HWN—, HOC(O)—, CH₂═CH-Ph-(O)ₚ₂, 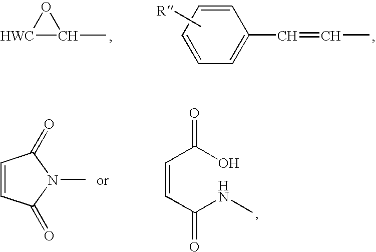
wherein:
W represents H, F, Cl, Br or I or a C₁₋₅ alkyl group;
p¹ is an integer having a value of from 1 to 9;
p² is an integer having a value of 0 or 1,
R′ represents a C₁₋₅ alkyl group;
R″ represents a C₁₋₅ alkyl group, methoxy, cyano, F, Cl, Br or I;
Ph represents phenylene; and
(Ph) represents phenyl.
Sp¹ represents an optionally-substituted C₁₋₂₀ alkylene group, in which one or more C-atoms may be replaced by a heteroatom or/and by an optionally substituted aromatic or non-aromatic carbocyclic or heterocyclic 3- to 10-membered ring system or/and it is optionally possible that one or more carbon-carbon single bonds are replaced by carbon-carbon double or triple bond;
m1 is an integer having a value of 0 or 1;
Y¹ represents —O—, —S—, —NH—, N(CH₃)—, —CH(OH)—, —CO—, —CH₂(CO)—, —SO—, —CH₂(SO)—, —SO₂—, —CH₂(SO₂)—, —COO—, —OCO—, —OCO—O—, —S—CO—, —CO—S—, —SOO—, —OSO—, —SOS—, —CH₂—CH₂—, —OCH₂—, —CH₂O—, —CH═CH—, or —C≡C—; and
k1 is an integer having a value of 0 or 1.

7. Compound according to claim 6, wherein the group Sp¹ represents an optionally-substituted C₁₋₂₀ alkylene group, in which one or more C-atoms may be replaced by a heteroatom and/or by an optionally substituted carbocyclic or heterocyclic 3-membered ring system and furthermore one or more carbon-carbon single bond may be replaced by a carbon-carbon double or triple bond.

8. Compound according to claims 6 or 7, wherein the C₁₋₂₀ alkylene group of Sp¹ may comprise branched or straight chain alkylene groups and may be unsubstituted, mono- or polysubstituted by F, Cl, Br, I or CN.

9. Compound according to anyone of claims 6 to 8, wherein one or more of CH₂ groups of the C₁₋₂₀ alkylene group of Sp¹ may be replaced, independently, by one or more groups selected from —O—, —S—, —NH—, —N(CH₃)—, —CH(OH)—, —CO—, —CH₂(CO)—, —SO—, —CH₂(SO)—, —SO₂—, —CH₂(SO₂)—, —COO—, —OCO—, —OCO—O—, —S—CO—, —CO—S—, —SOO—, —OSO—, —SOS—, —C≡C—, —(CF₂)_{q1}— or —C(W¹)═C(W²)—, with the proviso that two oxygen atoms are not directly linked to each other and
W¹ and W² each represent, independently, H, H—CH₂)_{q3}— or Cl, wherein the integers q1 to q3 each independently represent a number of between 1 and 15.

10. Compound according to anyone of claims 1 to 9, wherein the group A represents a group of formula (II):
P²-(Sp²)ₘ₁-Y²- III
wherein:
Y² represents —O—, —CO—, —COO—, —OCO—, —C≡C—, or a single bond, especially —O—, —COO—, —OCO— or a single bond;
Sp² represents a C₁₋₂₀ straight-chain alkylene group, especially ethylene, propylene, butylene, pentylene, hexylene, heptylene, octylene, nonylene, decylene, undecylene, or dodecylene; and
P² represents a polymerizable group such as : CH₂═CW³— or CH₂═CW³—(CO)ₚ₃O—
wherein:
W³ represents H, CH₃, F, Cl, Br or I; and
p3 is 0 or 1.

11. Compound according to anyone of claims 1 to 10, wherein Q¹ is selected from a residue of formula (IV):
P³-Sp¹-(Y¹)ₖ₁- IV
wherein:
P³ is hydrogen or a polymerizable group P¹ with the meaning given above; and
Sp¹, Y¹ and k1 have the meaning given above.

12. Compound according to anyone of claims 1 to 11, wherein Q¹ is selected from a residue of formula (V):
P⁴-Sp²-Y²- V
wherein:
P⁴ is hydrogen or a polymerizable group P² with the meaning given above; and
Sp² and Y² have the meaning given above.

13. Compound according to anyone of claims 1 to 12, wherein Q² is selected from a residue of formula (VI):
P⁵-(Sp¹)ₘ₁-(Y¹)ₖ₁- VI
wherein:
P⁵ is hydrogen, halogen; a polar group such as —CN, and —NO₂; or a polymerizable group P¹ with the meaning given above and with the proviso that Q¹ does not comprise a polymerizable group; and
Sp¹, m1, Y¹ and k¹ have the meaning given above.

14. Compound according to anyone of claims 1 to 13, wherein Q² is selected from a residue of formula (VII):
P⁶-(Sp²-Y²)ₘ₃- VII
wherein:
P⁶ is hydrogen; halogen; a polar group such as —CN, and —NO₂; or a polymerizable group P² with the meaning given above and with the proviso that Q¹ does not comprise a polymerizable group;
m3 is an integer having a value of 0 or 1; and
Sp² and Y² have the meaning given above.

15. Compound according to anyone of claims 1 to 14, wherein groups C¹ and C³ are selected from: 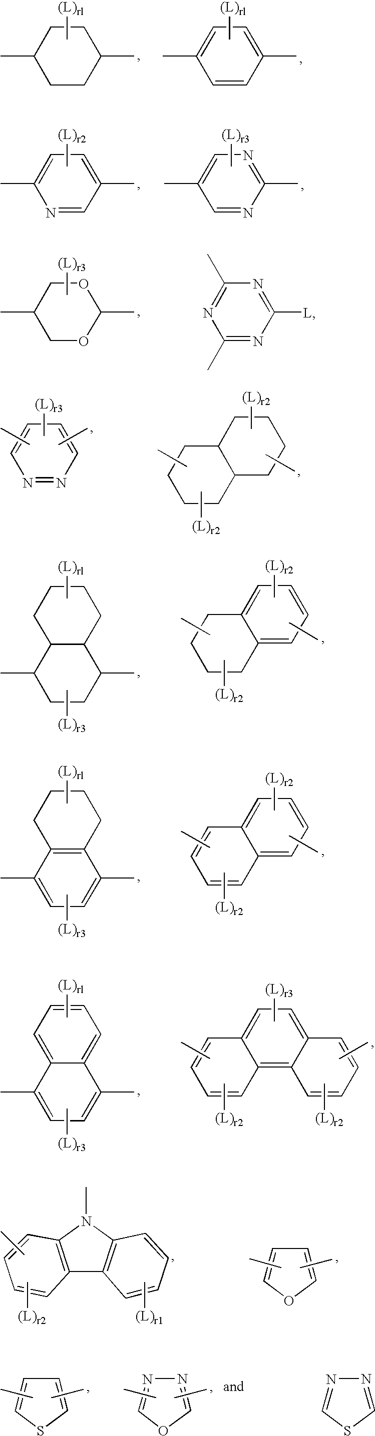
with:
L being —CH₃, —COCH₃, —NO₂, —CN, or halogen
r1 being 0, 1, 2, 3, or 4,
r2 being 0, 1; 2, or 3, and
r3 being 0, 1, or 2.

16. Compound according to claim 15, wherein C¹ and C³ are selected from the group consisting of optionally-substituted trans-1,4-cyclohexylene, 1,4-phenylene and 2,6-naphthylenediyl.

17. Compound according to anyone of claims 1 to 16, wherein group C² is selected from: 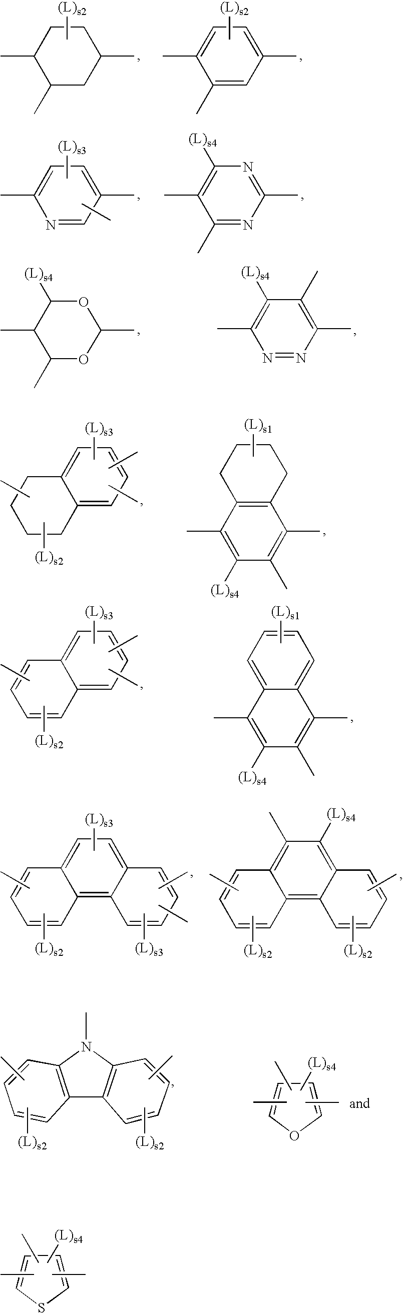
with:
L being —CH₃, —COCH₃, —NO₂, —CN, or halogen,
s1 being 0, 1, 2, 3, or 4,
s2 being 0, 1, 2, or 3,
s3 being 0, 1, or 2 and
s4 being 0 or 1.

18. Compound according to claim 17, wherein C² is selected from the group consisting of optionally-substituted 1,2,4-cyclohexatriyl, 1,2,4-benzenetriyl, 1,2,4-naphthenetriyl, 1,2,6-naphthenetriyl and 2,3,6-naphthenetriyl.

19. Compound according to anyone of claims 1 to 18, wherein X¹ and X² are independently selected from the group consisting of —COO—, —OCO—, —CH₂—CH₂—, —CH₂O—, —OCH₂—, —CH═CH—, —C≡C— and a single bond.

20. Compound according to claim 19, wherein X¹ and X² are independently selected from the group consisting of of —COO—, —OCO— and a single bond.

21. Compound according to anyone of claims 1 to 20, wherein n1 and n2 have independently a value from 1 to 3.

22. Compound according to anyone of claims 1 to 21, wherein the sum of n1+n2 is 2, 3 or 4.

23. Compound according to anyone of claims 1 to 22, wherein
A is a residue selected from the formula (VIII)
Y³-(Sp²)ₙ₃-P² VIII
wherein:
Y³ represents —O—, —COO—, —OCO— or a single bond;
n3 is an integer having a value of 0 or 1; and
Sp² and P² have the meaning given above;
Q¹ residue selected from the formula (IX)
P⁴-Sp²-Y³ IX
wherein:
P⁴, Sp² and Y³ have the meaning given above;
Q¹ is hydrogen; halogen; CN; a polymerizable group P² with the meaning given above and with the proviso that Q¹ does not comprise a polymerizable group; or a residue selected from the formula (X)
CH₃-(Sp²)ₙ₃-Y³ IX
wherein:
Sp², n3 and Y³ have the meaning given above;
C¹ to C³, X¹ and X² have the meaning given above; and
n1 and n2 are integers, wherein the sum of n1+n2 is 2, 3or 4.

24. Compounds of formula (I) according to claim 1 to 23, which are

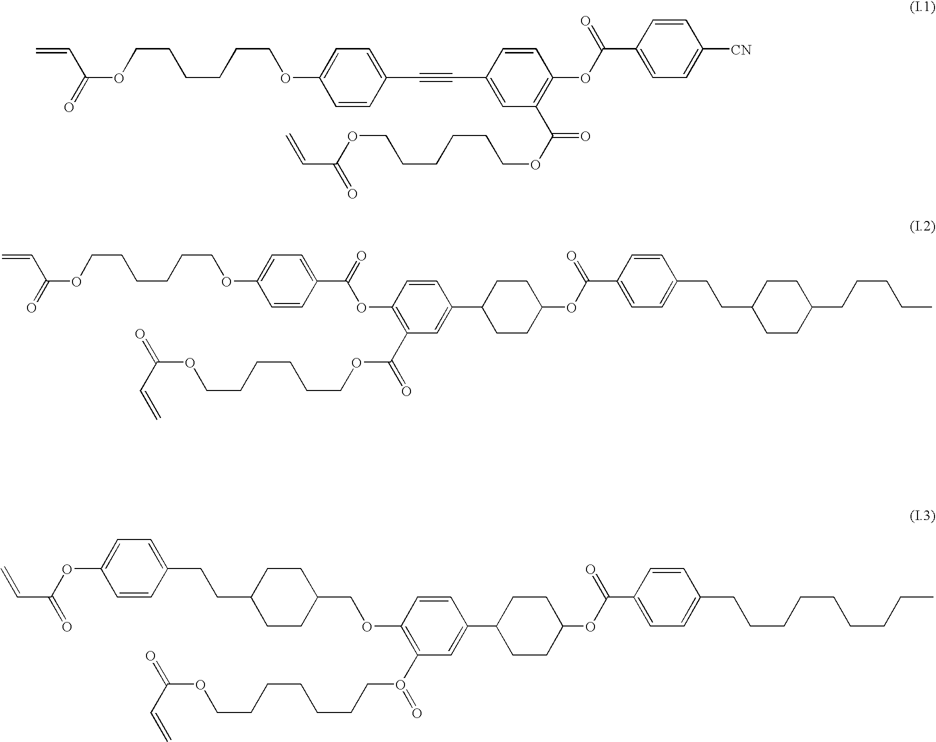

25. Use of compounds of formula (I) according to claim 1 to 24 alone or as a component of a liquid crystal mixture.

26. A liquid crystalline material comprising a compound of formula (I) according to claim 1 to 24.

27. A liquid crystalline material according to claim 26 comprising at least two components.

28. A liquid crystalline material according to claims 26 or 27, wherein the additional components are miscible with the compound of formula (I) and may be selected from known mesogenic materials.

29. A liquid crystalline material according to anyone of claims 26 to 28, wherein the liquid crystal material is in form of a liquid crystalline mixture, (co)polymer, elastomer, polymer gel or polymer network.

30. Use of a liquid crystalline material comprising a compound of formula (I) according to claim 1 to 24 in the manufacture of a liquid crystal polymer.

31. A polymer network comprising a compound of formula (I) in crosslinked or polymerized form.

32. A polymer network according to claim 31 comprising at least two components, at least one of which is a liquid crystalline compound of formula (I).

33. A polymer network according to claims 31 or 32 prepared by polymerization of liquid crystalline materials according to anyone of claims 26 to 29 on a substrate.

34. A polymer network according to claims 31 or 32 prepared by copolymerization of a mesogenic mixture comprising:
i) at least one chiral or/and achiral mesogenic polymerizable compound;
ii) at least one compound of formula I; and
iii) an initiator.

35. A polymer network according to claim 34, wherein the chiral or achiral mesogenic polymerizable compound is a liquid crystalline compound of formula (I) and/or selected from known mesogenic materials.

36. A polymer network according to claims 34 or 35, wherein the chiral or achiral mesogenic polymerizable compound has a thermotropic sequence which includes a nematic phase.

37. A polymer network according to anyone of claims 31 to 36 comprising further components.

38. A polymer network according to claim 37, wherein the components include additional polymerizable compounds, stabilizers and dyes.

39. A polymer network according to claim 38, wherein the additional polymerizable compounds comprise a non-mesogenic compound having at least one polymerizable functional group

40. A polymer network according to claim 39, wherein the polymerizable compound is a diacrylate.

41. A polymer network according to anyone of claims 34 to 40, wherein the chiral or achiral polymerizable mesogenic compound is present in an amount from 0.01 to 99% by weight.

42. A polymer network according to claim 41, wherein the chiral or achiral polymerizable mesogenic compound is present in an amount from 50 to 95% by weight.

43. A polymer network according to anyone of claims 32 to 42, wherein the liquid crystalline compound of formula (I) may be present in an amount from 0.1 to 100% by weight.

44. A polymer network according to claim 43, wherein the liquid crystalline compound of formula (I) may be present in an amount from 0.1 to 50% by weight

45. Use of a polymer network according to anyone of claims 31 to 44 in the manufacture of devices such as waveguides, optical gratings, filters, retarders, rotators, piezoelectric cells or thin films exhibiting non-linear optical properties.

46. An optical or electro-optical component containing a polymer network comprising a compound of formula (I).

47. An optical or electro-optical component according to claim 46 which is a waveguide, an optical grating, a filter, a retarder, a rotator, a piezoelectric cell or a non-linear optical cell or film.
